(19) United States
(12) Patent Application Publication
(10) Pub. No.: US 2022/0119925 A1
(43) Pub. Date: Apr. 21, 2022

(54) ALLOY FOR ADDITIVE MANUFACTURING AND METHOD

(71) Applicant: Siemens Energy Global GmbH & Co. KG, Munich, Bayern (DE)

(72) Inventors: David Rule, Pompano Beach, FL (US); Fabio Witte, Gävle (SE)

(73) Assignee: Siemens Energy Global GmbH & Co. KG, Munich, Bayern (DE)

(21) Appl. No.: 17/418,523

(22) PCT Filed: Dec. 13, 2019
(86) PCT No.: PCT/EP2019/085096

§ 371 Date: Jun. 25, 2021

(30) Foreign Application Priority Data
Jan. 7, 2019 (EP) 19150502.3

(51) Int. Cl. C22C 19/07; B22F 3/105; B33Y 10/00; B33Y 70/00

(52) U.S. Cl. CPC C22C 19/07; B33Y 70/00; B33Y 10/00; B22F 3/105

(57) ABSTRACT

An alloy especially for additive manufacturing, which includes (in wt %): Boron (B) 0.01%-0.1%; Titanium (Ti) 0.15%-0.3%; Chromium (Cr) 22.5%-24.25%; Carbon (C) 0.55%-0.6%; Nickel (Ni) 10.0%-15.0%; Tantalum (Ta) 3.0%-4.0%; especially 3.5%; Iron (Fe) 1.0%-4.0%; Zirconium (Zr) 0.05%-0.6%; Tungsten (W) 6.5%-7.5%; optionally: Aluminum (Al) 0%-0.15%; Manganese (Mn)<0.1%, further optionally, but as low as possible Molybdenum (Mo), Niobium (Nb), Phosphor (P), Sulfur (S), Silicon (Si), Selenium (Se), Copper (Cu), Nitrogen (N), Oxygen (O), Hafnium (Hf), remainder Cobalt (Co).

### CROSS REFERENCE TO RELATED APPLICATIONS

This application is the US National Stage of International Application No. PCT/EP2019/085096 filed 13 Dec. 2019, and claims the benefit thereof. The International Application claims the benefit of European Application No. EP19150502 filed 7 Jan. 2019. All of the applications are incorporated by reference herein in their entirety.

### FIELD OF INVENTION

The invention relates to alloy and a method for additive manufacturing.

### BACKGROUND OF INVENTION

Selectively laser melted metals form large amounts internal residual stresses during the printing process, this means metals with low ductility or low weldability can be difficult to produce in the selective laser melting process. Cobalt-based alloys are commonly used in the hot section of a gas turbine due to their high melting points, high thermal conductivities and strength at high temperature. High temperature cobalt alloys are primarily strengthened with carbide precipitates which results in low ductility at lower temperatures. This low ductility leads to cracks forming in notched areas in the SLM process.

Only relatively low strength Co-based alloys have been utilized so far in the SLM process.

Those processes using high temperature Cobalt based alloys exhibit instability or inconsistencies in producing crack free parts.

### SUMMARY OF INVENTION

It is therefore aim of the invention to overcome the problems mentioned above.

The problem is solved by an alloy and a method according to the independent claims.

In the dependent claims further advantages a listed which can be arbitrarily combined with each other to yield further advantages.

The technical feature which solves the problem of low ductility and cracking of Cobalt based alloys in the SLM process is a change of the chemical composition.

### DETAILED DESCRIPTION OF INVENTION

The invention comprises an alloy, especially for additive manufacturing, which comprises (in wt %):, especially consists of:

| | |
|---|---|
| Boron (B) | 0.01%-0.1% |
| Titanium (Ti) | 0.15%-0.3% |
| Chromium (Cr) | 22.5%-24.25% |
| Carbon (C) | 0.55%-0.6% |
| Nickel (Ni) | 10.0%-15.0% |
| Tantalum (Ta) | 3.0%-4.0% especially 3.5% |
| Iron (Fe) | 1.0%-4.0% |
| Zirconium (Zr) | 0.05%-0.6% |
| Tungsten (W) | 6.5%-7.5% |

optionally:

| | |
|---|---|
| Aluminum (Al) | 0%-0.15% |
| Manganese (Mn) | <0.1% |

further optionally, but as low as possible

Molybdenum (Mo)

Niobium (Nb)

Phosphor (P)

Sulfur (S)

Silicon (Si)

Selenium (Se)

Copper (Cu)

Nitrogen (N)

Oxygen (O)

Hafnium (Hf)

remainder Cobalt (Co).

Boron (B) was added to a level between 0.01%-0.1% to increase stress rupture strength and ductility. The effect of Boron is a strengthening of grain boundaries. Percentages of up to 0.1% are found to significantly increase rupture properties by increasing ductility.

Molybdenum (Mo) was set to a level ‘as low as possible’. Molybdenum lowers the stacking fault energy of the material and stabilizes layers and small islands of less ductile HCP phase. The total result of this is lower ductility of the material.

Nickel (Ni) level was set to 10%-15% to additionally increase the stacking fault energy and increase stability of FCC phase. This would lead to higher ductility. If the stacking fault energy is increased enough in this way, the result would favor lattice recovery vs recrystallization and would lead to increase grain size. For SLM materials, small grain sizes are a barrier for high temperature creep performance.

Silicon (Si) was set to a level ‘as low as possible’. Silicon has been observed to increase Laves phase formation and loss of ductility or ‘embrittlement’ in Cobalt based alloys.

In Nickel alloys, this element is also often responsible for solidification micro-cracking and loss of ductility in grain boundaries.

Iron (Fe) levels were set to levels between 1%-4%, this should have similar results to the nickel additions, but may have an even larger effect.

The content of Aluminum (Al) is especially between 0.12% and 0.15%, very especially 0.15%.

The content of Boron (B) is especially between 0.02% and 0.1%, especially between 0.05% and 0.1%.

The Carbon (C) content is especially 0.6%.

The content on Nickel (Ni) is between 12.0% and 15%, especially between 13% to 15%, very especially 14% to 15%.

The content on Iron (Fe) is between 2.0% and 4%, especially between 3% to 4%, very especially 4%.

The content on Zirconium (Zr) is between 0.075% to 0.6%, especially 0.3% to 0.6%, very especially 0.3% to 0.4%.

The Titanium (Ti) content is especially 0.23%.

The Chromium (Cr) content is especially 23.3%.

The Tungsten (W) content is especially 7.0%.

1. An alloy, which comprises (in wt %):

| | |
|---|---|
| Boron (B) | 0.01%-0.1% |
| Titanium (Ti) | 0.15%-0.3% |
| Chromium (Cr) | 22.5%-24.25% |
| Carbon (C) | 0.55%-0.6% |
| Nickel (Ni) | 10.0%-15.0% |
| Tantalum (Ta) | 3.0%-4.0% |
| Iron (Fe) | 1.0%-4.0% |
| Zirconium (Zr) | 0.05%-0.6% |
| Tungsten (W) | 6.5%-7.5% |

optionally:

| | |
|---|---|
| Aluminum (Al) | 0%-0.15% |
| Manganese (Mn) | <0.1% |

further optionally, but as low as possible
Molybdenum (Mo)
Niobium (Nb)
Phosphor (P)
Sulfur (S)
Silicon (Si)
Selenium (Se)
Copper (Cu)
Nitrogen (N)
Oxygen (O)
Hafnium (Hf)
remainder Cobalt (Co).

2. An additive manufacturing method, comprising:
additively manufacturing using an alloy according to claim 1,
especially additive manufacturing by an energy beam assisted sintering or melting,
very especially additive manufacturing by a selective laser sintering or selective laser melting or energy beam assisted powder welding, especially laser powder welding.

3. The alloy according to claim 1,
wherein the content of Aluminum (Al) is between 0.12% and 0.15%,
especially 0.15%.

4. The alloy according to claim 1,
wherein the content of Boron (B) is between 0.02% and 0.1%,
especially between 0.05% and 0.1%.

5. The alloy according to claim 1,
wherein the Carbon (C) content is 0.6%.

6. The alloy according to claim 1,
wherein the content of Nickel (Ni) is between 12.0% and 15.0%,
especially between 13.0% to 15.0%,
very especially 14.0% to 15.0%.

7. The alloy according to claim 1,
wherein the content of Iron (Fe) is between 2.0% and 4.0%,
especially between 3.0% to 4.0%,
very especially 4.0%.

8. The alloy according to claim 1,
wherein the content of Zirconium (Zr) is between 0.075% to 0.6%.

9. The alloy according to claim 1,
wherein the content of Zirconium (Zr) is between 0.5% to 0.6%,
very especially 0.55% to 0.6%.

10. The alloy according to claim 1,
wherein the content of Zirconium (Zr) is between 0.3% to 0.4%,
very especially 0.35%.

11. The alloy according to claim 1,
wherein the Titanium (Ti) content is 0.23%.

12. The alloy according to claim 1,
wherein the Chromium (Cr) content is 23.3%.

13. The alloy according to claim 1,
wherein the Tungsten (W) content is 7.0%.

14. The alloy according to claim 1,
wherein the alloy is for additive manufacturing.

15. An alloy, wherein the alloy consists of the elements (in wt %) of claim 1.

16. The alloy according to claim 1,
wherein Tantalum (Ta) is 3.5%.
